(19) United States
(12) Patent Application Publication
(10) Pub. No.: US 2014/0281096 A1
(43) Pub. Date: Sep. 18, 2014

(54) BROADCASTING DEVICE WITH COMMUNICATION MECHANISM

(71) Applicant: G-TEK ELECTRONICS CORPORATION, New Taipei City (TW)

(72) Inventor: Cheng-Fu LIN, New Taipei City (TW)

(73) Assignee: G-TEK ELECTRONICS CORPORATION, New Taipei City (TW)

(21) Appl. No.: 13/826,073

(22) Filed: Mar. 14, 2013

(51) Int. Cl. H04H 20/53

(52) U.S. Cl. CPC H04H 20/53
USPC 710/303

(57) ABSTRACT

A broadcasting device with communication mechanism applied to a handheld device includes a body, a control module, a sound broadcasting module, and a communication module; an upper portion of the body has an interchangeable connecting member electrically connecting with the handheld device; the control module is in the body and electrically connects with the connecting member; the sound broadcasting module is at the lateral portion of the body and electrically connects with the control module, and broadcasts the sound from the handheld device; the communication module is at the lateral portion of the body and electrically connects with the control module, and broadcasts sound through the sound broadcasting module.

### BACKGROUND OF THE INVENTION

1. Field of the Invention

The present invention generally relates to a broadcasting device, more particularly to a broadcasting device with communication mechanism.

2. Description of the Related Art

Currently, for life entertainment, the handheld device has become indispensable work, such as document processing, connections of related people, funny games, etc. Since the built-in sound broadcasting module in the handheld device plays sound with small volume, so a broadcasting device is often used to amplify sound files or songs in the handheld device.

Prior broadcasting device has a body, a control module and a sound broadcasting module; an upper portion of the body is shaped as an indentation slot, and an interchangeable connecting member is in the indentation slot; the control module is in the body and electrically connects with the connecting member; the sound broadcasting module has a pair of loudspeakers that is at a lateral portion of the body; while in use, a side of the handheld device is in the indentation slot and electrically connects with the connecting member, so that the sound signals from the handheld device are transmitted to the control module through the connecting member, and the sound signals are broadcasted by the loudspeakers after the control module processing.

The prior broadcasting device is with a disadvantage, that is, the broadcasting device only has the function of broadcasting sound, so the broadcasting device has no further added value while the handheld device broadcasts sound signals without using the broadcasting device, and therefore the rate of usage of the broadcasting device is not high enough.

### SUMMARY OF THE INVENTION

The object of the present invention is to a broadcasting device with communication mechanism, wherein a sound broadcasting module and a communication module are in a body in order to let the broadcasting device have the functions of broadcasting sound and phone communication, so that the rate of usage of the broadcasting device is increased.

To approach above object, the broadcasting device with communication mechanism provided by the present invention applied to a handheld device comprises a body, a control module, a sound broadcasting module, and a communication module; an upper portion of the body has an interchangeable connecting member electrically connecting with the handheld device; the control module is in the body and electrically connects with the connecting member; the sound broadcasting module is at the lateral portion of the body and electrically connects with the control module, and broadcasts the sound from the handheld device; the communication module is at the lateral portion of the body and electrically connects with the control module, and broadcasts sound through the sound broadcasting module.

The present invention has advantages listed below:

1. A room phone line electrically connects with the control module via a digital signal connecting port in order to let the broadcasting device be as a room phone and amplify sound from the room phone line.

2. Through a wireless communication module receiving sound from a wireless phone, the broadcasting device has the function of amplifying the sound from the wireless phone.

3. The handheld device transmits sound signals to the broadcasting device through a bluetooth communication module or a USB connecting port, or to the wireless phone via a wireless communication module for the wireless phone broadcasting sound.

4. Sound signals in a USB flash drive are forwarded to the broadcasting device via the USB connecting port, and the sound signals are broadcasted by the sound broadcasting module.

5. The broadcasting device provides power to the handheld device through a power storage module for charging.

6. Through a touch screen, operation statuses of the broadcasting device are displayed and the broadcasting device is controlled.

7. The wireless communication module cooperates with the communication module so as to let the wireless communication module be able to receive sound signals from and forward sound signals to a wireless telephone transmitter.

8. The power in the power storage module can be backup power for the broadcasting device.

9. The broadcasting device is able to deliver sound information through a network connecting port and a network line, and hence the broadcasting device can be as a network phone.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic assemble view of the broadcasting device of the present invention;

FIG. 2 illustrates a schematic circuit view of the broadcasting device of the present invention;

FIG. 3 illustrates a schematic reference view I of usage of the broadcasting device of the present invention; and

FIG. 4 illustrates a schematic reference view II of usage of the broadcasting device of the present invention.

### DETAILED DESCRIPTION OF THE INVENTION

Following preferred embodiments and figures will be described in detail so as to achieve aforesaid objects.

Please refer to FIG. 1 and FIG. 2, which illustrate a schematic assemble view of the broadcasting device of the present invention and a schematic circuit view of the broadcasting device of the present invention. The broadcasting device 1 provided by the present invention is applied to a handheld device 91 and has a body 10, a control module 20, a sound broadcasting module 30, and communication module 40.

The upper portion of the body 10 is shaped as an indentation slot 11 and has an interchangeable connecting member 12 as Apple connector, lightning connector, and Micro USB connector. One side of the handheld device 91 is accommodated in the indentation slot 11. The connecting member 12 is in the indentation slot 11 and electrically connects with the handheld device 91 that can be a USB connecting port plug. The body 10 has a front surface 13 and a lateral surface 14, and the lateral surface 14 is at one side of the front surface 13.

The control module 20 is in the body 10 and electrically connects with the connecting member 12 of the body 10.

The sound broadcasting module 30 is at the front surface 13 of the body 10 and includes a pair of loudspeakers 31. The loudspeakers 31 electrically connect with the control module 20 respectively. The sound broadcasting module 30 broadcasts the sound from the handheld device 91.

The communication module 40 is at the lateral portion of the body 10 and electrically connects with the control module 20, and broadcasts sound through the sound broadcasting module 30. The communication module 40 includes an input component 41, an SIM connecting port 42 and a radio unit 43. The input component 41 is at the front surface 13 of the body 10 and in between the loudspeakers 31. The input component 41 electrically connects with the control module 20 and includes a plurality of buttons 411. The SIM connecting port 42 is at the lateral surface 14 of the body 10 and electrically connects with the control module 20. As a matter of fact, the SIM connecting port 42 electrically connects with an SIM card 92 and accommodates the SIM card 92. The radio unit 43 is in the body 10 and electrically connects with the control module 20.

In addition, the lateral surface 14 of the body 10 further has a USB connecting port 15, a digital signal connecting port 16, a power connecting port 17, and a network connecting port 18.

The USB connecting port 15 is at an upper portion of the lateral surface 14 and electrically connects with the control module 20. The USB connecting port 15 is applied to a USB flash drive 93, that is, the USB flash drive 93 electrically connects with the control module 20 through the USB connecting port 15.

The digital signal connecting port 16 is at the lateral surface 14 of the body 10 and electrically connects with the control module 20. The digital signal connecting port 16 is applied to a room phone line 94 for electrical connection, and the room phone line 94 electrically connects with the control module 20 through the digital signal connecting port 16 that is an RJ11 connecting port.

The power connecting port 17 is at the lateral surface 14 of the body 10 and electrically connects with the control module 20. The power connecting port 17 is applied to a power line 95 for electrical connection. The control module 20 electrically connects with a power supply device 96 through the power line 95.

The network connecting port 18 is at the lateral surface 14 of the body 10 and electrically connects with the control module 20. The network connecting port 18 is applied to a network line 98 for electrical connection and is an RJ45 connecting port.

The broadcasting device 1 further has a touch screen 50, a sound receiving module 60, a wireless communication module 71, a bluetooth communication module 72, and a power storage module 80.

The touch screen 50 is at the front surface 13 of the body 10 and electrically connects with the control module 20. Further, the touch screen 50 is in between the loudspeakers 31 of the sound broadcasting module 30 and at an upper side of the input component 41 of the communication module 40.

The sound receiving module 60 is at the lateral surface 14 of the body 10 and electrically connects with the control module 20. The sound receiving module 60 is to receive sound outside the broadcasting device 1. In practice, the sound receiving module 60 is a built-in microphone, a sound receiving connecting port for external microphone or a module having the built-in microphone and the sound receiving connecting port.

The wireless communication module 71 is in the body 10 and electrically connects with the control module 20 and receives sound signals from a wireless phone 97 or sends sound signals to the wireless phone 97.

The bluetooth communication module 72 is in the body 10 and electrically connects with the control module 20, and receives sound signals from the handheld device 91 or other electronic devices, or sends sound signals to the handheld device 91 or other electronic devices.

The power storage module 80 is in the body 10 and electrically connects with the control module 20. Further, the power storage module 80 supplies power to the handheld device 91 through the connecting member 12 for charging the handheld device 91.

Please refer to FIG. 3 and FIG. 4, which illustrate a schematic reference view I of usage of the broadcasting device of the present invention and a schematic reference view II of usage of the broadcasting device of the present invention. Firstly, one side of the handheld device 91 is disposed in the indentation slot 11 of the body 10 in order to electrically connect the connecting member 12 of the body 10 with the handheld device 91. The sound signals in the handheld device 91 can be sent to the control module 20 through the connecting member 12. The sound signals are transformed by the control module 20 to the sound signals that are read by the sound broadcasting module 30. The transformed sound signals are thus processed by the sound broadcasting module 30 and delivered to the loudspeakers 31 for broadcasting sound for the handheld device 91.

The SIM card 92 can be disposed in the SIM connecting port 42 and electrically connects with the control module 20 via the SIM connecting port 42. Thus the buttons 411 of the input component 41 are pressed in order to generate signals of a set of phone number and make a phone call. Through the reception of the radio unit 43, the received sound signals are processed by the control module 20 and broadcasted by the loudspeakers 31 of the sound broadcasting module 30. Sound outside the broadcasting device 1 can be received by the sound receiving module 60, then is transformed by the control module 20 to sound signals, and the sound signals are sent out by the radio unit 43. Hence, the broadcasting device 1 can be as a phone after installing the SIM card 92.

The room phone line 94 electrically connects with the control module 20 via the digital signal connecting port 16, so that sound signals are then delivered to the control module 20 through the digital signal connecting port 16, and the sound signals processed by the control module 20 are broadcasted by the sound broadcasting module 30. On the other hand, sound from user can be received by the sound receiving module 60 and transformed to sound signals, continuously the sound signals are processed by the control module 20 and sent to the room phone line 94 by means of the digital signal connecting port 16, and therefore the sound signals are carried out via the room phone line 94. As mentioned above, the broadcasting device 1 can be operated as a room telephone and amplify sound of sound signals from the room phone line 94.

More, through the wireless communication module 71, sound signals from the wireless phone 97 are received, and the received sound signals are processed by the control module 20 and broadcasted by the sound broadcasting module 30. On the other hand, sound from user can be received by the sound receiving module 60 and transformed to sound signals, continuously the sound signals are processed by the control module 20 and sent to the wireless phone 97 by means of the wireless communication module 71, and therefore sound from the wireless phone 97 is amplified. The wireless communication module 71 is able to cooperate with the communication module 40, thus, signals of a phone number are transmitted by the wireless communication module 71 to the control module 20 for processing after the phone number is dialed by the wireless phone 97, and continuously the signals are delivered to the communication module 40 for broadcasting. Then, sound from user is received via a wireless telephone transmitter, and the wireless communication module 71 receives the sound signals from the wireless telephone transmitter. The wireless communication module 71 sends the sound signals to the control module 20 to process, and the processed sound signals are transmitted to the radio unit 43. On the contrary, the radio unit 43 is able to receive sound signals from a remote talker and transmit the sound signals to the control module 20 for processing and to the wireless communication module 71, and consequently, the wireless communication module 71 conveys the sound signals to the wireless telephone transmitter in order to broadcast sound.

Besides, the broadcasting device 1 is capable of receiving the sound signals from the handheld 91 by means of the bluetooth communication module 72, and the sound signals are processed by the control module 20 and broadcasted by the sound broadcasting module 30, and the effect of amplifying sound from the handheld device 91 is achieved. Further, by means of electrically connecting the handheld device 91 to the USB connecting port 15, the sound signals from the handheld device 91 are transmitted to the control module 20 through the USB connecting port 15. After the control module 20 processing the sound signals, the sound broadcasting device 30 broadcasts sound. Or, the sound signals from the handheld device 91 may be transmitted to the control module 20 through the bluetooth communication module 72 or the USB connecting port 15. After the control module 20 processing the sound signals, the sound signals are forwarded to the wireless communication module 71, then to the wireless phone 97 by means of the wireless communication module 71, and are broadcasted via the wireless phone 97. On the contrary, after the sound sequentially received by the wireless phone 97 are processed and transformed by the wireless phone 97 and the control module 20 to sound signals, the sound signals are forwarded to the handheld device 91 via the bluetooth communication module 72 or the USB connecting port 15. More, the USB flash drive 93 electrically connects with the control module 20 via the USB connecting port 15, and thus sound signals in the USB flash drive 93 are dispatched to the control module 20. After the control module 20 processes the sound signals to broadcasted sound signals, the sound broadcasting module 30 is able to play the broadcasted sound signals.

The broadcasting device 1 electrically connects with the network connecting port 18 and a network via the network line 98, and transmits information signals or sound signals in the broadcasting device 1 to a network through the network connecting port 18; or information signals or sound signals in a network are transmitted by the broadcasting device 1 to the control module 20 via the network connecting port 18, and the signals are played by the sound broadcasting module 30, stored in the handheld device 91 or the USB flash drive 93 after the control module processing. Since the broadcasting device 1 forwards sound information to a network by means of the network connecting port 18 and the network line 98, the broadcasting device 1 can be as a network phone.

By means of electrically connecting two ends of the power line 95 with the power connecting port 17 and the power supply device 96 respectively, power provided by the power supply device 96 is dispatched to the power storage module 80 through the power line 95 and the power connecting port 17, therefore the power storage module 80 provides power to the control module 20 and then to the connecting member 12 and the handheld device 91 for charging. Besides, power from the power storage module 80 is delivered to the broadcasting device 1 through the control module 20. So, the power storage module 80 is a backup battery of the broadcasting device 1.

Except for above mention, the touch screen 50 promptly displays the operation status of the broadcasting device 1 and controls the processing procedures of the broadcasting device 1, such as select different songs or sound files in the handheld device 91, etc., or make the wireless communication module 71 or the bluetooth communication module 72 be activated or turned off.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. A broadcasting device (1) with communication mechanism applied to a handheld device (91), comprising:
a body (10), of which an upper portion has an interchangeable connecting member (12) electrically connecting with the handheld device (91);
a control module (20), being in the body (10) and electrically connecting with the connecting member (12);
a sound broadcasting module (30), being at a lateral portion of the body (10), electrically connecting with the control module (20), and broadcasting sound from the handheld device (91); and
a communication module (40), being at the lateral portion of the body (10), electrically connecting with the control module (20), and broadcasting the sound through the sound broadcasting module (30).

2. The broadcasting device (1) with communication mechanism according to claim 1, wherein the upper portion of the body (10) is shaped as an indentation slot (11) for accommodating the handheld device (91), and the connecting member (12) is in the indentation slot (11).

3. The broadcasting device (1) with communication mechanism according to claim 2, wherein the body (10) has a front surface (13) and a lateral surface (14) at a side of the front surface (13), the communication module (40) comprising an input component (41), an SIM connecting port (42) and a radio unit (43), the sound broadcasting module (30) and the input component (41) being at the front surface (13) respectively, the SIM connecting port (42) being at the lateral surface (14), the radio unit (43) being in the body (10), the input component (41), the SIM connecting port (42) and the radio unit (43) electrically connecting with the control module (20) respectively.

4. The broadcasting device (1) with communication mechanism according to claim 3, wherein the sound broadcasting module (30) comprises a pair of loudspeakers (31), the loudspeakers (31) being at two sides of the input component (41), the input component (41) having a plurality of buttons (411).

5. The broadcasting device (1) with communication mechanism according to claim 4 further comprising a touch screen (50), the touch screen (50) being at the front surface (13) and electrically connecting with the control module (20), the touch screen (50) being in between the loudspeakers 31 and at an upper side of the input component (41).

6. The broadcasting device (1) with communication mechanism according to claim 3, wherein the body (10) further has a USB connecting port (15), the USB connecting port (15) being at an upper portion of the lateral surface (14) and electrically connecting with the control module (20).

7. The broadcasting device (1) with communication mechanism according to claim 3, wherein the body (10) further has a digital signal connecting port (16) and a network connecting port (18), the digital signal connecting port (16) and the network connecting port (18) being at the lateral surface (14) respectively and electrically connecting with the control module (20).

8. The broadcasting device (1) with communication mechanism according to claim 7, wherein the digital signal connecting port (16) is an RJ11 connecting port and the network connecting port (18) is an RJ45 connecting port.

9. The broadcasting device (1) with communication mechanism according to claim 3, wherein the body (10) further has a power connecting port (17), the power connecting port (17) being at the lateral surface (14) and electrically connecting with the control module (20).

10. The broadcasting device (1) with communication mechanism according to claim 1 further comprising a sound receiving module (60), the sound receiving module (60) being at the lateral surface (14) and electrically connecting with the control module (20).

11. The broadcasting device (1) with communication mechanism according to claim 1 further comprising a wireless communication module (71), the wireless communication module (71) being in the body (10) and electrically connecting with the control module (20).

12. The broadcasting device (1) with communication mechanism according to claim 1 further comprising a bluetooth communication module (72), the bluetooth communication module (72) being in the body (10) and electrically connecting with the control module (20).

13. The broadcasting device (1) with communication mechanism according to claim 1 further comprising a power storage module (80), the power storage module (80) being in the body (10) and electrically connecting with the control module (20), the power storage module (80) supplying power to the handheld device (91) through the connecting member (12).

14. The broadcasting device (1) with communication mechanism according to claim 13, wherein power storage module (80) is a backup battery for supplying power to the broadcasting device (1).
